(19) United States
(12) Patent Application Publication
(10) Pub. No.: US 2011/0122260 A1
(43) Pub. Date: May 26, 2011

(54) CAMERA MODULE

(75) Inventor: Kenji Nakamura, Osaka (JP)

(73) Assignee: PANASONIC CORPORATION, Osaka (JP)

(21) Appl. No.: 12/867,802

(22) PCT Filed: Feb. 18, 2009
(86) PCT No.: PCT/JP2009/000678

§ 371 Date: Aug. 16, 2010

(30) Foreign Application Priority Data
Feb. 20, 2008 (JP) 2008-039430

(51) Int. Cl. H04N 5/225

(52) U.S. Cl. 348/207.1; 348/E05.024

(57) ABSTRACT

A camera module allowing for its downsizing and reducing power consumption transmits and receives data to and from another apparatus via wireless communication, and includes: a camera unit capturing object images and providing information of the images as image data; a memory in which the data is stored; an antenna unit used for wireless transmission and reception; a wireless IC unit wirelessly transmitting the data; a power supply unit receiving electromagnetic waves used for wireless communication via the antenna unit and generating power by electromagnetic induction through the electromagnetic waves or by a radiated electromagnetic field; a power supply unit supplying the power at least to the camera unit; and a memory power control unit selecting one of the power supply units as a power source of the memory according to a state of the camera module.

### TECHNICAL FIELD

The present invention relates to a camera module, and in particular to a camera module that transmits and receives data to and from another apparatus via wireless communication.

### BACKGROUND ART

With miniaturization of camera imaging units, digital cameras have been used in various fields, such as monitoring and medical care. The digital cameras used in such monitoring and medical care fields need to record images in memories, and thus include high-capacity memories, for example, nonvolatile memories. Then, after the images are recorded in the memories, that is, after the images are captured, the images are removed. When the digital cameras include nonvolatile memories, for example, the nonvolatile memories are connected to external computers, and the external computers obtain the images captured by the digital cameras. In addition, when the digital cameras do not include nonvolatile memories, for example, the digital cameras are connected to external computers. The images captured by the digital cameras are respectively transmitted as image data via signal transmission cables that connect the digital cameras to the external computers so that the external computers obtain the image data.

Furthermore, the digital cameras used in various fields, such as monitoring and medical care include wireless digital camera equipment which includes an imaging device and a radio transmitter in a casing. However, there is a problem that an operating time of the wireless digital camera equipment is short because the radio transmitter consumes a large amount of current. Furthermore, there is another problem that the size of camera equipment becomes larger with inclusion of the radio transmitter.

Thus, what has been suggested is a method of transmitting a control signal for controlling image data or a camera with the inclusion of a wireless device in a digital camera (see Patent Reference 1).

Furthermore, in recent years, a method using a non-contact IC card technique has also been suggested as one of non-contact communication techniques (see Patent Reference 2). Patent Reference 2 suggests a wireless IC that operates with power supplies obtained from electromagnetic induction through external electromagnetic waves or from a radiated electromagnetic field, without any power supply from batteries.

The following describes the conventional technique in Patent Reference 1.

FIG. 9 is a block diagram illustrating a configuration of a conventional camera module 900.

The camera module 900 includes a camera unit 910, a memory 920, a wireless IC unit 930, an antenna unit 940, and a power supply unit 950.

The camera unit 910 includes an imaging optical system 911 that forms an image of an object, an imaging element 912 that converts image information including to optical signals of the object into an electrical signal, and a DSP 913 for signal processing that converts the electrical signal into a digital signal.

The camera unit 910 forms the image of the object through the imaging optical system 911, and then the imaging element 912 converts the image into the image data indicated by the electrical signal corresponding to the image information. The DSP 913 digitalizes the obtained image data of the electrical signal with predetermined processing. The digitalized image data is provided to the memory 920.

The image data captured by the camera unit 910 is stored in the memory 920.

The wireless IC unit 930 wirelessly transmits the image data stored in the memory 920 through the antenna unit 940.

The power supply unit 950 includes a battery and a constant potential circuit, and supplies power to the imaging element 912 and the DSP 913 of the camera unit 910, the memory 920, and the wireless IC unit 930.

Furthermore, the power supply unit 950 always supplies power to the wireless IC 930 and the memory 920.

FIGS. 10A, 10B, and 10C illustrate imaging sequences of the conventional camera module 900. FIG. 10A illustrates an imaging sequence of the camera unit 910, power supply sources of the camera unit 910, the memory 920, and the wireless IC unit 930, and a consumed state of a battery in the power supply unit 950. FIG. 10B illustrates power supply sources and a power supply path 991 when images are captured. FIG. 10C illustrates power supply sources, a power supply path 992, and transmission-reception electromagnetic waves 993, while the wireless IC unit 930 is operating.

As illustrated in FIGS. 10A, 10B, and 10C, the power supply unit 950 supplies power to the wireless IC unit 930 and the memory 920, while the wireless IC unit 930 is operating or stops the operation (while the camera unit 910 is capturing images).

### Patent Reference 1: Japanese Unexamined Patent Application Publication No. 2006-270308

### Patent Reference 2: Japanese Patent No. 3528899

### DISCLOSURE OF INVENTION

### Problems that Invention is to Solve

However, Patent Reference 1 has the following problems.

The power supply unit 950 included in the camera module 900 functions, for example, not only as a power supply source of the wireless IC unit 930 and the memory 920 that is a nonvolatile memory, but also as a power supply source for operating the wireless IC unit 930. Wireless transmission consumes a large amount of power, and frequent wireless transmission causes the battery of the power supply unit 950 to be rapidly consumed, so that the operating time of the camera equipment is shortened (the number of captured images decreases). In order to increase the operating time, upsizing of the battery in the power supply unit 950 is necessary, leading to the upsizing of the camera equipment itself.

The present invention has been conceived in view of the problems, and has an object of providing a camera module allowing for its downsizing and reduction in the power consumption.

### Means to Solve the Problems

In order to solve the problems, a camera module according to an aspect of the present invention is a camera module that transmits and receives data to and from an other apparatus via wireless communication, and includes: a camera unit configured to capture images of objects and provide information of the captured images as image data; a memory in which the image data is stored; an antenna unit used for transmission and reception via wireless communication; a wireless communication unit configured to transmit the image data via wireless communication; an electromagnetic-wave power supply unit configured to receive electromagnetic waves used for wireless communication via the antenna unit and to generate power by electromagnetic induction through the received electromagnetic waves or by a radiated electromagnetic field; a power supply unit configured to supply the power at least to the camera unit; and a memory power control unit configured to select one of the electromagnetic-wave power supply unit and the power supply unit as a power source of the memory according to a state of the camera module.

With the configuration, the memory power control unit can switch the power supply source of the memory from the power supply unit to the electromagnetic-wave electric power supply unit according to the state of the camera module so as not to waste the power of the power supply unit. Accordingly, the power supplied by the power supply unit to operate the memory can be reduced. Thus, the power consumed by the power supply unit is smaller in amount even with frequent wireless transmission, and the operating time of the camera equipment is not shortened (the number of captured images does not decrease). In addition, there is no need to upsize the power supply unit to increase the operating time. Thereby, the camera module allowing for its downsizing and reduction in the power consumption can be implemented.

Here, the memory power control unit may be configured to select the electromagnetic-wave power supply unit while the wireless communication unit is transmitting the image data or receiving the control information.

With the configuration, since the memory power control unit can switch the power supply source of the memory from the power supply unit to the electromagnetic-wave electric power supply unit as soon as the wireless communication unit starts operating, the power supplied by the power supply unit to operate the memory can be reduced. Thus, the power consumed by the power supply unit is smaller in amount even with frequent wireless transmission, and the operating time of the camera equipment is not shortened (the number of captured images does not decrease). In addition, there is no need to upsize the power supply unit to increase the operating time. Thereby, the camera module allowing for its downsizing and reduction in the power consumption can be implemented.

Furthermore, the wireless communication unit may be further configured to receive, via wireless communication, control information for controlling the camera unit, and the camera unit may be configured to capture the images according to the control information.

With the configuration, the camera control information received by the wireless communication unit is stored in the memory, so that an operating condition of the camera unit 110 can be externally changed via wireless communication.

Furthermore, the memory power control unit may be configured to select the power supply unit when an amount of the power generated by the electromagnetic-wave power supply unit is equal to or smaller than a predetermined threshold.

Thereby, the power supply at least necessary for operating the camera module can be guaranteed. Since the power supply source of the memory can be switched from the power supply unit to the electromagnetic-wave electric power supply unit while the power supply at least necessary for operating the camera module is guaranteed, the power supplied by the power supply unit to operate the memory can be reduced.

Furthermore, the memory may be a nonvolatile memory, and the memory power control unit may be further configured to stop the power supply to the memory, while the camera unit and the wireless communication unit are not operating.

Thereby, the camera module allowing for reduction in the power consumption can be implemented.

Furthermore, the wireless communication unit may be configured to store the received control information in the memory, the camera unit may be configured to capture the images according to the camera control information stored in the memory, and the camera control information may include at least one of an image-capturing start signal, an exposure time, a gain at the time of capturing the images, and image-capturing intervals.

Thereby, an operating condition of the camera unit in the camera module can be externally changed via wireless communication.

Furthermore, the wireless communication unit may be configured not to transmit the image data stored in the memory while the camera unit is capturing the images.

Furthermore, new image data may not be stored in the memory while the wireless communication unit is transmitting the image data or receiving the control signal.

With the exclusive control, the image data to be stored in the memory can be prevented from being overwritten.

Furthermore, the camera unit may include: an imaging element that captures the images of the objects; and a signal processing unit configured to perform signal processing on the information of the images captured by the imaging element, and provide the processed information as the image data, and the signal processing unit may be further configured to control the camera unit, the memory, and the wireless communication unit.

Furthermore, the wireless communication unit, the electromagnetic-wave power supply unit, and at least one of the memory and the memory power control unit may be included in an integrated circuit.

Furthermore, the signal processing unit, and at least one of the memory and the memory power control unit may be included in an integrated circuit.

In order to solve the problems, an integrated circuit included in a camera module according to an aspect of the present invention is an integrated circuit included in a camera module that transmits and receives data to and from an other apparatus via wireless communication and includes a camera unit that captures images of objects and provides information of the captured images as image data, and includes: a memory in which the image data is stored; an antenna unit used for transmission and reception via wireless communication; a wireless communication unit configured to transmit the image data via wireless communication; an electromagnetic-wave power supply unit configured to receive electromagnetic waves used for wireless communication via the antenna unit and to generate power by electromagnetic induction through the received electromagnetic waves or by a radiated electromagnetic field; a power supply unit configured to supply the power at least to the camera unit; and a memory power control unit configured to select one of the electromagnetic-wave power supply unit and the power supply unit as a power source of the memory according to a state of the camera module.

### Effects of the Invention

According to the present invention, the camera module allowing for its downsizing and reduction in the power consumption can be implemented.

More specifically, since the power consumed when the wireless communication unit transmits image data can be practically eliminated, and the power consumption necessary for operating the camera module can be substantially reduced, the operating time of the camera module whose power is supplied by the power supply unit can be substantially increased.

Furthermore, the camera control information received by the wireless communication unit is stored in the memory, so that an operating condition of the camera unit can be externally changed via wireless communication.

### BRIEF DESCRIPTION OF DRAWINGS

FIG. 1 is a block diagram illustrating a configuration of a camera module according to the present invention.

FIG. 2 is a conceptual scheme illustrating an example of a usage status of a camera module according to Embodiment 1 in the present invention.

FIG. 3A illustrates imaging sequences of the camera module according to Embodiment 1 in the present invention.

FIG. 3B illustrates imaging sequences of the camera module according to Embodiment 1 in the present invention.

FIG. 3C illustrates imaging sequences of the camera module according to Embodiment 1 in the present invention.

FIG. 4 illustrates imaging sequences of the camera module according to Embodiment 2 in the present invention.

FIG. 5 illustrates imaging sequences of the camera module according to Embodiment 2 in the present invention.

FIG. 6 is a block diagram illustrating a configuration of a camera module according to Embodiment 3 in the present invention.

FIG. 7 is a block diagram illustrating a configuration of a camera module according to Embodiment 4 in the present invention.

FIG. 8 is a block diagram illustrating a configuration of a camera module according to Embodiment 5 in the present invention.

FIG. 9 is a block diagram illustrating a configuration of a conventional camera module.

FIG. 10A illustrates imaging sequences of the conventional camera module.

FIG. 10B illustrates imaging sequences of the conventional camera module.

FIG. 10C illustrates imaging sequences of the conventional camera module.

### NUMERICAL REFERENCES

100, 300, 500, 700, 900 Camera module
110, 910 Camera unit
111, 911 Imaging optical system
112, 912 Imaging element
113, 713, 913 DSP
120, 320, 720 Memory
130, 330, 530, 930 Wireless IC unit
131, 150, 950 Power supply unit
132 Transmitting/receiving circuit
133 Logic circuit
140, 940 Antenna unit
141 Capacitor
142 Antenna coil
151 Battery
152 Constant potential circuit
160, 360, 560, 760 Memory power control unit
191, 192, 991, 992 Power supply path
193, 993 Transmission-reception electromagnetic waves
200 Transmitting/receiving device
201 Antenna coil
202 Radio-wave transmitting/receiving unit
203 Received data storage unit
204 Camera control signal generating unit
920 Memory

### BEST MODE FOR CARRYING OUT THE INVENTION

Embodiments according to the present invention will be described with reference to drawings hereinafter. Since Embodiments to be described hereinafter are only examples, various modifications are possible in Embodiments including examples of the variations to be described later.

### Embodiment 1

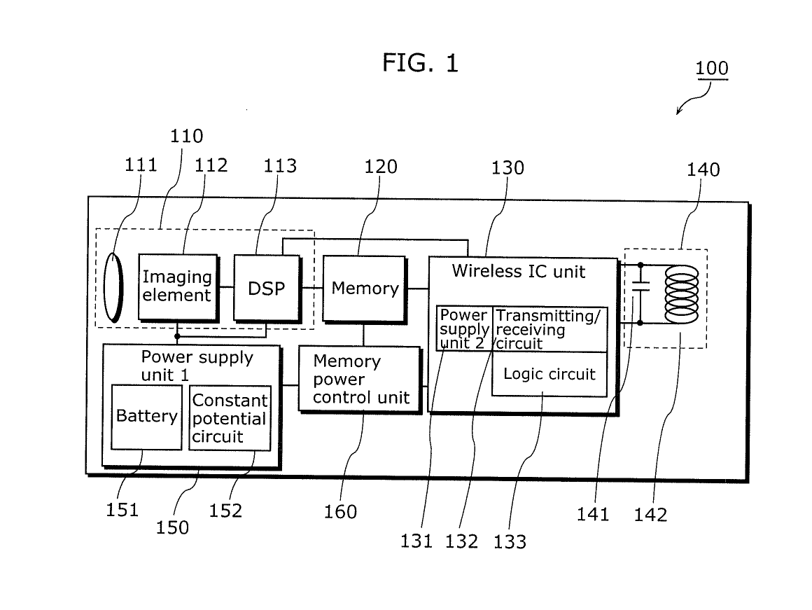

FIG. 1 is a block diagram illustrating a configuration of a camera module 100 according to Embodiment 1 in the present invention.

The camera module 100 includes a camera unit 110, a memory 120, a wireless IC unit 130, an antenna unit 140, a power supply unit 150, and a memory power control unit 160.

The camera unit 110 includes an imaging optical system 111, an imaging element 112, and a DSP 113 for signal processing. The camera unit 110 captures images of objects to be captured, and stores image data of the captured images in the memory 120.

The imaging optical system 111 includes, for example, a lens and a lens barrel holding the lens, and forms the image of the object to be captured by the camera module 100 on a photo-receiving surface of the imaging element 112.

The imaging element 112 is, for example, a charge-coupled device or an MOS imaging device, and converts image information indicating the image of the object that has been formed through the imaging optical system 111 into an electrical signal.

The DSP 113 converts the electrical signal indicating the image information into a digital signal. In other words, the DSP 113 performs predetermined processing on the image data converted by the imaging element 112 into the electrical signal and indicating the object to obtain the digitalized image data. The digitalized image data is provided to the memory 120, and is stored therein.

The DSP 113 includes, for example, a Central Processing Unit (CPU) and a Read Only Memory (ROM). Furthermore, the DSP 113 controls the imaging element 112, the memory 120, and the wireless IC unit 130 in coordination with various programs stored in the ROM. For example, the DSP 113 controls an image-capturing operation, a data-storing operation, and wireless communication, and performs the processing thereof.

The digitalized image data provided from the camera unit 110 is stored in the memory 120. Furthermore, various configuration data of the camera module 100 is stored in the memory 120.

Furthermore, the memory 120 is, for example, a volatile memory, such as a Static Random Access Memory (SRAM) and a Synchronous Dynamic Random Access Memory (SDRAM), or a nonvolatile memory, such as a FLASH-ROM, an EEPROM, and a FRAM. Since the nonvolatile memory is suitable for the memory 120, the following description is based on the assumption that the memory 120 is a nonvolatile memory.

The antenna unit 140 includes a capacitor 141 and an antenna coil 142. The antenna unit 140 is connected to the wireless IC unit 130. The antenna unit 140 generates power by electromagnetic induction through the received high frequency electromagnetic waves or by a radiated electromagnetic field, with the capacitor 141 and an antenna coil 142. The antenna unit 140 supplies the generated power to the wireless IC unit 130.

The wireless IC unit 130 includes a power supply unit 131, a transmitting/receiving circuit 132, and a logic circuit 133. The wireless IC unit 130 wirelessly transmits the image data stored in the memory 120 through the antenna unit 140. Furthermore, the wireless IC unit 130 stores, in the memory 120, the data received through the antenna unit 140.

The power supply unit 131 makes the power provided from the antenna unit 140 constant. The power supply unit 131 provides the constant power to the logic circuit 133. Furthermore, the power supply unit 131 supplies part of the constant power to the memory power control unit 160. Simultaneously, the power supply unit 131 transmits, to the memory power control unit 160, an indication signal indicating that power to be used by the memory 120 and the memory power control unit 160 should be supplied from the power supply unit 131.

The transmitting/receiving circuit 132 modulates the image data transmitted from the logic circuit 133 into a radio frequency signal, and superimposes the radio frequency signal onto carrier waves. The transmitting/receiving circuit 132 transmits, through the antenna unit 140, the image data modulated into the radio frequency signal.

Simultaneously, the transmitting/receiving circuit 132 receives camera control information superimposed on the high frequency electromagnetic waves through the antenna unit 140. The transmitting/receiving circuit 132 demodulates the received camera control information, and provides the logic circuit 133 with the demodulated camera control information.

The logic circuit 133 reads the image data stored in the memory 120, and transmits the read image data to the transmitting/receiving circuit 132.

Furthermore, the logic circuit 133 stores, in the memory 120, the camera control information transmitted from the transmitting/receiving circuit 132.

The power supply unit 150 includes a constant potential circuit 152 and a battery 151 that is, for example, one of a primary battery and a secondary battery and powers the camera module 100. The constant potential circuit 152 may be replaced with a step-up circuit.

The power supply unit 150 supplies necessary power to each of the constituent elements of the camera module 100. Here, the constituent elements are the imaging element 112, the DSP 113, the memory 120, and the memory power control unit 160.

The memory power control unit 160 selects one of the wireless IC unit 130 and the power supply unit 150 as a power source of the memory 120, according to a state of the camera module 100, and supplies power of the selected source to the memory 120.

Furthermore, the memory power control unit 160 controls whether to supply power or stop the power supply to the memory 120, according to instructions from the camera unit 110 and the wireless IC unit 130.

For example, the memory power control unit 160 starts supplying power from the power supply unit 150 to the memory 120, in response to an indication signal that indicates the start of power supply and is received from the DSP 113 in the camera unit 110. In contrast, the memory power control unit 160 stops supplying power from the power supply unit 150 to the memory 120, in response to an indication signal that indicates the stop of power supply and is received from the DSP 113 in the camera unit 110.

Furthermore, for example, the memory power control unit 160 starts supplying power from the wireless IC unit 130 to the memory 120, in response to an indication signal that indicates the start of supply and is received from the wireless IC unit 130. In contrast, the memory power control unit 160 stops supplying power from the power supply unit 130 to the memory 120, in response to an indication signal that indicates the stop of power supply and is received from the DSP 113 in the camera unit 110.

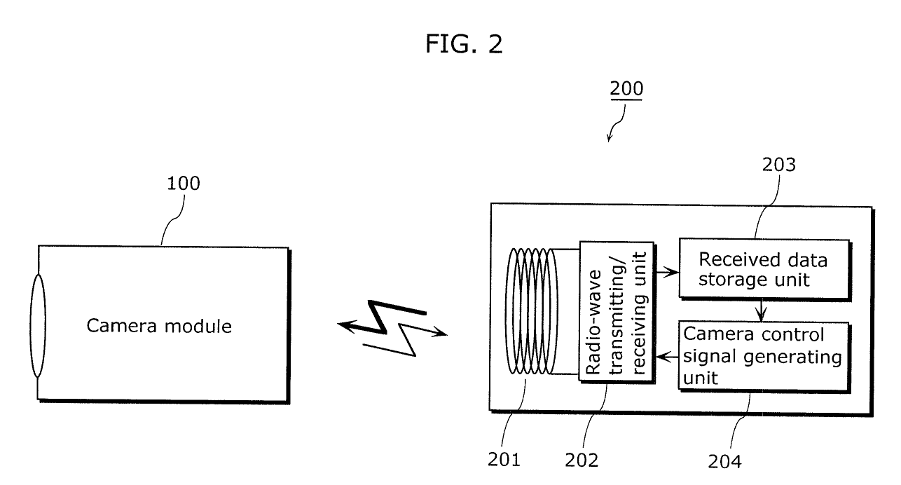

FIG. 2 is a conceptual scheme illustrating an example of a usage status of the camera module 100 according to Embodiment 1 in the present invention.

The camera module 100 is paired with a transmitting/receiving device 200, between which data is transmitted and received through radio waves.

The transmitting/receiving device 200 includes an antenna coil 201, a radio-wave transmitting/receiving unit 202, a received data storage unit 203, and a camera control signal generating unit 204.

The camera control signal generating unit 204 generates and provides a camera control signal indicating, for example, a gain at the time of capturing images and an exposure time.

The radio-wave transmitting/receiving unit 202 modulates the camera control signal transmitted from the camera control signal generating unit 204 into a radio frequency signal, and superimposes the radio frequency signal onto carrier waves. The radio-wave transmitting/receiving unit 202 oscillates the camera control signal superimposed on the carrier waves from the antenna coil 201 after the modulation into radio frequency signal. Furthermore, the radio-wave transmitting/receiving unit 202 demodulates the image data from the radio frequency signal received by the antenna coil 201. Then, the radio-wave transmitting/receiving unit 202 provides the received data storage unit 203 with the demodulated image data.

The received data storage unit 203 stores the image data provided from the radio-wave transmitting/receiving unit 202.

Next, a data transmission method performed between the camera module 100 and the transmitting/receiving device 200 via wireless communication will be described hereinafter.

When the camera module 100 receives electromagnetic waves from the transmitting/receiving device 200, the wireless IC unit 130 of the camera module 100 performs load modulation on the antenna unit 140 according to data to modulate the strength of the demagnetizing field generated by the electromagnetic waves.

The transmitting/receiving device 200 demodulates data corresponding to the load fluctuation of the antenna coil 201 that is generated by the demagnetizing field and modulated by the wireless IC unit 130 so as to receive data from the camera module 100. The wireless communication method has been brought into actual use, for example, as IC cards and RF tags. The wireless communication method is suitable because there is no need to provide any power supply source for wireless transmission in the camera module 100.

There is no change in the effect of generating an electromotive force by the wireless IC unit 130 using either not an electromagnetic induction method but only a radiated electromagnetic field, or using both of the methods. Accordingly, differences between the methods for generating power by the wireless IC unit 130 do not affect the implementations of the present invention.

Next, the operations when the camera module 100 and the transmitting/receiving device 200 exchange camera control information and image data will be described.

First, the camera unit 110 transmits, to the memory power control unit 160, an indication signal indicating the start of power supply from the power supply unit 150 to the memory 120.

Next, the memory power control unit 160 supplies power from the power supply unit 150 to the memory 120 in response to the indication by the indication signal from the camera unit 110.

Next, the camera unit 110 captures images of objects based on the camera control information (for example, a gain and an to exposure time) stored in the memory 120. The camera unit 110 stores image data of the captured images of the objects in the memory 120.

Next, when the image data is stored in the memory 120, the DSP 113 of the camera unit 110 provides (i) the imaging element 112 with an indication signal indicating a transition to a sleep state, and (ii) the memory power control unit 160 with an indication signal indicating stop of power supply from the power supply unit 150 to the memory 120.

The imaging element 112 transitions to the sleep state according to an indication by the indication signal from the DSP 113. Here, the sleep state is a state of stopping circuit operations or a state closer to the stop, where the power consumption is zero or extremely small.

Furthermore, the memory power control unit 160 stops power supply from the power supply unit 150 to the memory 120 in response to an indication by the indication signal from the DSP 113.

Since the memory 120 is a nonvolatile memory, even when the memory power control unit 160 stops power supply, the image data and camera control information that are stored in the memory 120 are never lost.

When the memory 120 is not a nonvolatile memory, as long as the memory power control unit 160 do not stop power supply even after the camera unit 110 finishes capturing images, the camera module 100 is operable. However, the advantage of reducing the power consumption in Embodiment 1 according to the present invention is extremely diminished.

Next, when the antenna unit 140 of the camera module 100 receives high frequency electromagnetic waves oscillated by the transmitting/receiving device 200, the wireless IC unit 130 provides the memory power control unit 160 with an indication signal indicating that the power to be used by the memory 120 and the memory power control unit 160 should be supplied from the wireless IC unit 130. More specifically, the power supply unit 131 makes constant the voltage generated by electromagnetic induction of the antenna coil 142 or by a radiated electromagnetic field, and provides the generated power to the logic circuit 133. At the same time, it provides part of the generated power to the memory power control unit 160. Furthermore, the power supply unit 131 transmits an indication signal indicating that the power to be used by the memory 120 and the memory power control unit 160 should be supplied from the power supply unit 131.

Next, the memory power control unit 160 starts supplying power from the wireless IC unit 130 to the memory 120, in response to an indication signal that indicates the start of power supply and received from the wireless IC unit 130.

Next, in the wireless IC unit 130, the logic circuit 133 reads the image data from the memory 120, and transmits the read image data to the transmitting/receiving circuit 132.

Next, in the wireless IC unit 130, the transmitting/receiving circuit 132 modulates the image data transmitted from the logic circuit 133 into a radio frequency signal, superimposes the radio frequency signal onto carrier waves, and transmits the resulting carrier waves from the antenna coil 142.

At the same time, in the wireless IC unit 130, the transmitting/receiving circuit 132 demodulates the camera control information superimposed on the received high frequency electromagnetic waves, and provides the logic circuit 133 with the demodulated camera control information. The logic circuit 133 stores, in the memory 120, the camera control information demodulated by the transmitting/receiving circuit 132.

As described above, the camera module 100 and the transmitting/receiving device 200 exchange the camera control information and the image data.

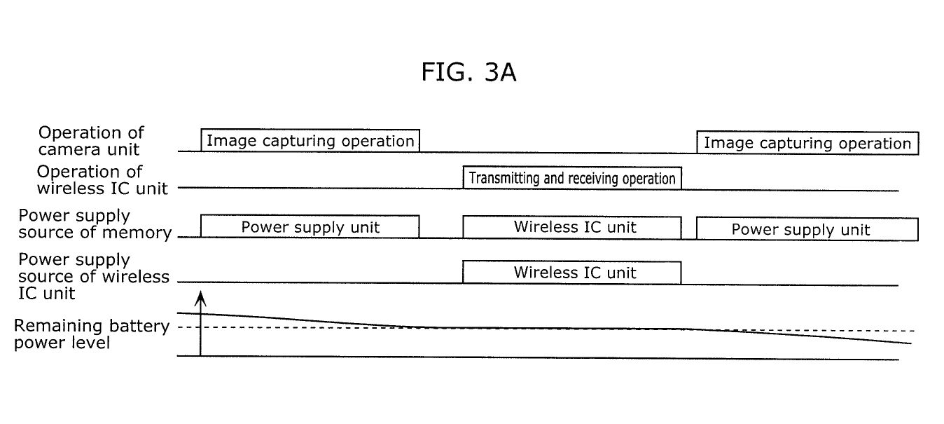

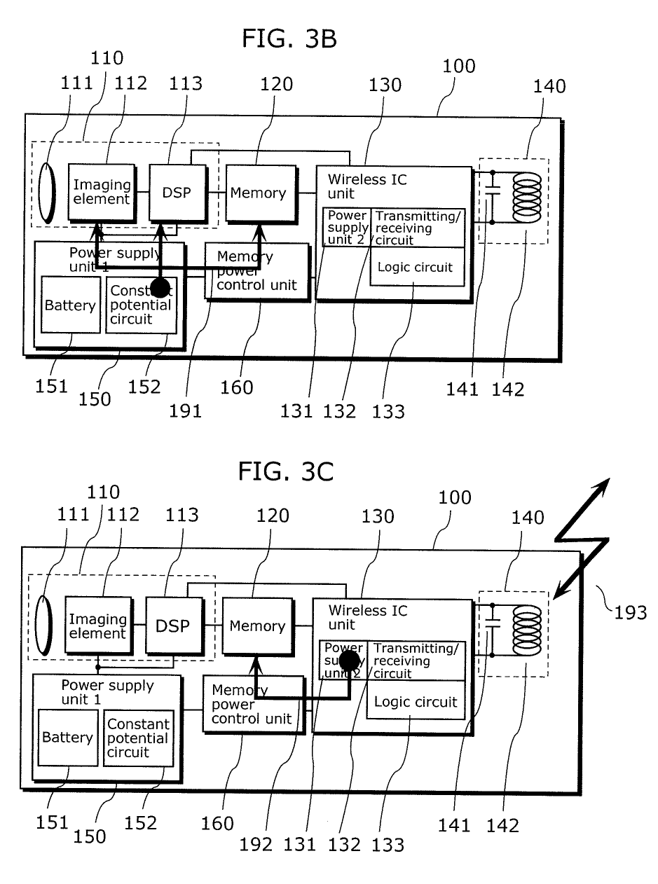

FIGS. 3A, 3B, and 3C illustrate imaging sequences of the camera module 100 according to Embodiment 1 in the present invention. FIG. 3A illustrates power supply sources of the memory 120 and the wireless IC unit 130 in the imaging sequences, and a consumed state of the battery 151 in the power supply unit 150 at the time of power supply. FIG. 3B illustrates power supply sources in capturing images and a power supply path 191 through which the power is supplied. FIG. 3C illustrates power supply sources while the wireless IC unit 130 is operating, a power supply path 192 through which the power is supplied, and transmission-reception electromagnetic waves 193.

According to FIGS. 3A, 3B, and 3C, while the camera unit 110 is capturing images, the memory power control unit 160 selects the power supply unit 150 as a power source of the memory 120, and supplies the power from the power supply unit 150 to the memory 120. In contrast, while the wireless IC unit 130 is operating, the memory power control unit 160 selects the wireless IC unit 130 as a power source of the memory 120, and supplies the power from the wireless IC unit 130 to the memory 120. In other words, the memory power control unit 160 selects one of the wireless IC unit 130 and the power supply unit 150 as a power source of the memory 120, according to a state of the camera module 100 that may receive an indication signal so as not to waste the power of the power supply unit 150, and supplies the power of the selected power source to the memory 120.

Thereby, while the camera unit 110 is capturing images or the wireless IC unit 130 is operating, the power consumed by the battery 151 in the power supply unit 150 can be smaller than the power to be supplied from the power supply unit 150 to the wireless IC unit 130 and the memory 120.

Thereby, since the power consumed when the wireless IC unit 130 transmits image data can be practically eliminated and the power consumption necessary for operating the camera module 100 can be substantially reduced, the operating time of the camera module 100 with the battery 151 in the power supply unit 150 can be substantially increased.

Furthermore, the camera control information received by the wireless IC unit 130 is stored in the memory 120, so that an operating condition of the camera unit 110 can be externally changed via wireless communication.

Here, while the camera module 100 and the wireless IC unit 130 are not operating, the memory power control unit 160 stops power supply to the memory 120 as described above. Thereby, the power consumption of the battery 151 in the power supply unit 150 can be further reduced.

Furthermore, when the power generated by the power supply unit 131 of the wireless IC unit 130 is equal to or smaller than a predetermined threshold, the memory power control unit 160 switches to the power supply unit 150 for the power supply to the memory 120. Thereby, the power supply at least necessary for operating the camera module 100 can be guaranteed.

Furthermore, the camera unit 110 is activated at intervals predetermined by a ROM and others or at regular intervals for capturing images based on the configuration data stored in the memory 120 so as to perform capturing operations. Here, when the capturing operations start, the camera unit 110 detects that the wireless IC unit 130 is operating, and prevents the wireless IC unit 130 from performing the next capturing operations. With the exclusive control, the camera unit 110 can prevent the image data from being overwritten in the memory 120.

As described above, the adaptive switching of power supply to the memory 120 between the wireless IC unit 130 and the power supply unit 150 can reduce power consumption of the wireless IC unit 130 and the memory power control unit 160. Here, the wireless IC unit 130 applies one of the electromagnetic induction method and the radiated electromagnetic field as the wireless system.

Since the power consumed by the battery 151 of the power supply unit 150 is smaller in amount even with frequent wireless transmission and the operating time of the camera equipment is not shortened (the number of captured images does not decrease), there is no need to upsize the battery 151 for increasing the operating time. Thereby, the camera module 100 allowing for its downsizing and reduction in the power consumption can be implemented.

The camera unit 110 may start capturing images as soon as it detects that the wireless IC unit 130 has received an image-capturing start signal. The camera unit 110 may start capturing images as soon as it detects the image-capturing start signal included in a camera control signal stored in the memory 120 at regular intervals.

Furthermore, the timing when the wireless IC unit 130 starts operating may be detected, for example, using an indication signal that indicates the power supply and is provided from the wireless IC unit 130 to the memory power control unit 160. In such a case, upon detection of the indication signal, the capturing operations of the camera unit 110 are stopped.

### Embodiment 2

The following describes Embodiment 2. The description of the same configuration and operations as those of Embodiment 1 will be omitted.

Although Embodiment 1 describes a case where the image-capturing operation by the camera unit 110 and the operation by the wireless IC unit 130 are mutually exclusive, Embodiment 2 describes a case where these operations are simultaneously performed.

First, as soon as starting to capture images, the camera unit 110 transmits, to the memory power control unit 160, an indication signal indicating that the power to be used by the memory 120 should be supplied from the power supply unit 150.

Here, while the wireless IC unit 130 is not operating, the memory power control unit 160 supplies power from the power supply unit 150 to the memory 120 in response to the indication signal from the camera unit 110.

When the wireless IC unit 130 is operating, the memory power control unit 160 selects the wireless IC unit 130 as a power source of the memory 120, and supplies the power from the wireless IC unit 130 to the memory 120.

Next, the camera unit 110 captures images of objects based on camera control information (for example, a gain and an exposure time) stored in the memory 120. The camera unit 110 stores image data of the captured images of the objects in the memory 120. Here, the wireless IC unit 130 receives the camera control information superimposed on the high frequency electromagnetic waves via the antenna unit 140 concurrently or in parallel with the capturing operation by the camera unit 110, and transmits the image data stored in the memory 120.

Next, after the image data is stored in the memory 120, the DSP 113 provides (i) the imaging element 112 with an indication signal indicating a transition to a sleep state, and (ii) the memory power control unit 160 with an indication signal indicating stop of power supply from the power supply unit 150 to the memory 120.

The imaging element 112 transitions to the sleep state according to the indication by the indication signal from the DSP 113.

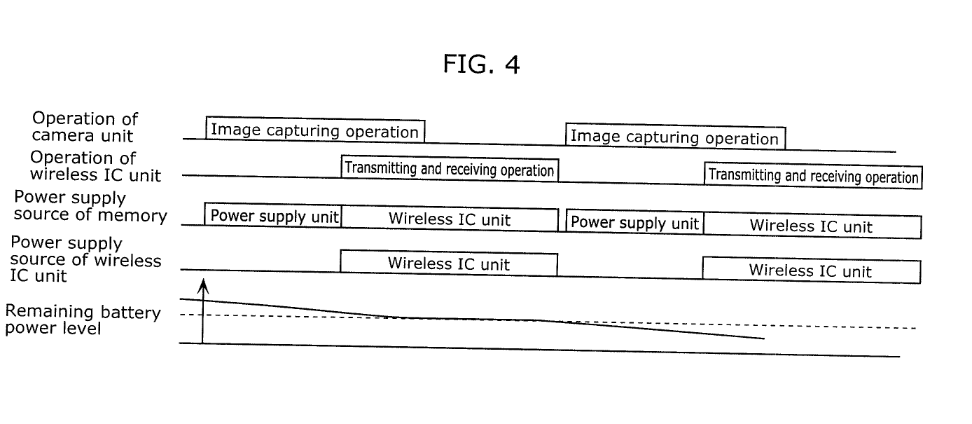

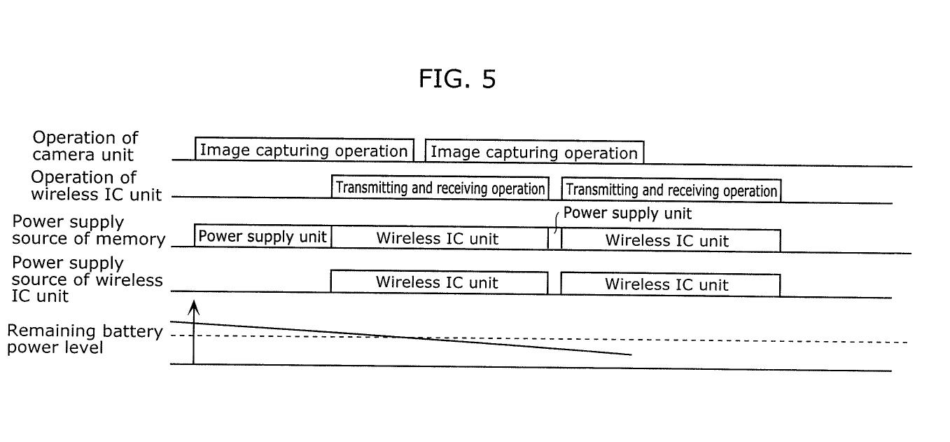

FIGS. 4 and 5 illustrate imaging sequences of the camera module 100 according to Embodiment 2 in the present invention.

FIG. 4 illustrates a case where the wireless IC unit 130 starts wireless operations while the camera unit 110 is capturing images, and the camera unit 110 does not start the next operation until the wireless IC unit 130 finishes the wireless operations (that is, the end of transmission from the wireless IC unit 130).

FIG. 5 illustrates a case where the camera unit 110 captures the images concurrently or in parallel with the wireless operations by the wireless IC unit 130 (that is, the transmission and reception from the wireless IC unit 130).

Here, when the camera unit 110 captures the images concurrently or in parallel with the wireless operations by the wireless IC unit 130, it is prevented that the image data provided by the camera unit 110 is overwritten on the image data that is being transmitted by the wireless IC unit 130. In other words, the image-capturing operations by the camera unit 110 and the transmission by the wireless IC unit 130 are performed by sequentially switching between an area in the memory 120 where the image data to be provided by the camera unit 110 is stored and an area in the memory 120 where the image data to be transmitted by the wireless IC unit 130 is stored. In other words, a storage area of the memory 120 is divided into areas, and the image data to be captured by the camera unit 110 and the image data to be transmitted by the wireless IC unit 130 are stored in the different areas, respectively. Thus, it is prevented that the captured image data is overwritten on the image data to be transmitted.

As described above, as soon as the wireless IC unit 130 starts operating, the memory power control unit 160 switches the power supply source of the memory 120 from the power supply unit 150 to the wireless IC unit 130.

In other words, the memory power control unit 160 switches the power supply source of the memory 120 from the power supply unit 150 to the wireless IC unit 130 according to a state of the camera module 100 so as not to waste the power of the power supply unit 150 as much as possible. Accordingly, the power to operate the memory 120 can be reduced.

Thus, the power consumed by the battery 151 of the power supply unit 150 is smaller in amount even with frequent wireless transmission, and the operating time of the camera equipment is not shortened (the number of captured images does not decrease). Since there is no need to upsize the battery 151 to increase the operating time, the camera equipment can be prevented from being upsized. Thereby, the camera module 100 allowing for its downsizing and reduction in the power consumption can be implemented.

Even when the wireless IC unit 130 starts operating, the power supply unit 150 may continue to supply the memory 120 with power as another embodiment that is not the best mode for the present invention. Even with the case, the effect of the present invention can be obtained.

### Embodiment 3

The following describes Embodiment 3. The description of the same configuration and operations as those of Embodiments 1 and 2 will be omitted.

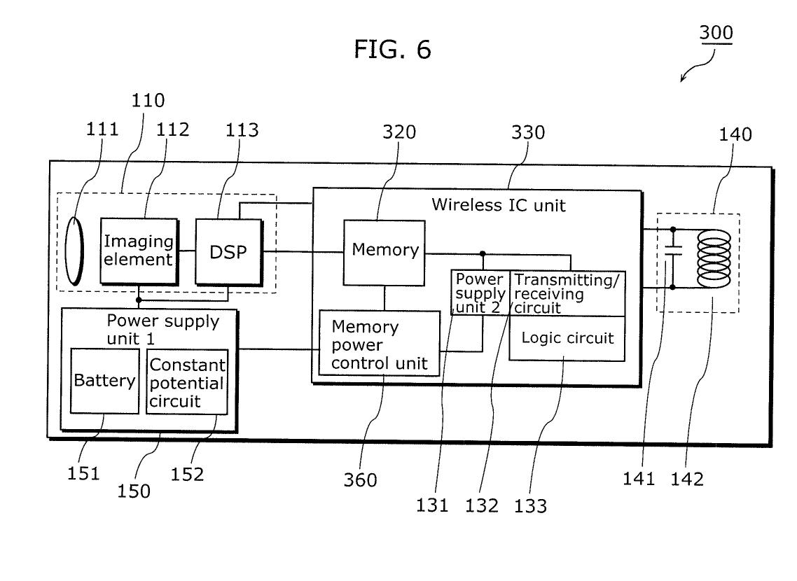

FIG. 6 is a block diagram illustrating a configuration of a camera module 300 according to Embodiment 3 in the present invention. FIG. 6 illustrates an example of the configuration different from those of Embodiments 1 and 2.

Embodiment 3 differs from Embodiment 1 in that the memory 120, the wireless IC unit 130, and the memory power control unit 160 are different constituent elements in Embodiment 1, whereas a wireless IC unit 330 includes a memory 320 and a memory power control unit 360 in Embodiment 3.

Since the operating sequences of the camera module 300 and the transmitting/receiving device 200 are the same as those of Embodiment 1 or Embodiment 2, the description will be omitted.

With the configuration of the camera module 300 in Embodiment 3, the number of components to be mounted on the camera module 300 can be reduced. Thus, the camera module can be further downsized.

### Embodiment 4

The following describes Embodiment 4. The description of the same configuration and operations as those of Embodiments 1 to 3 will be omitted.

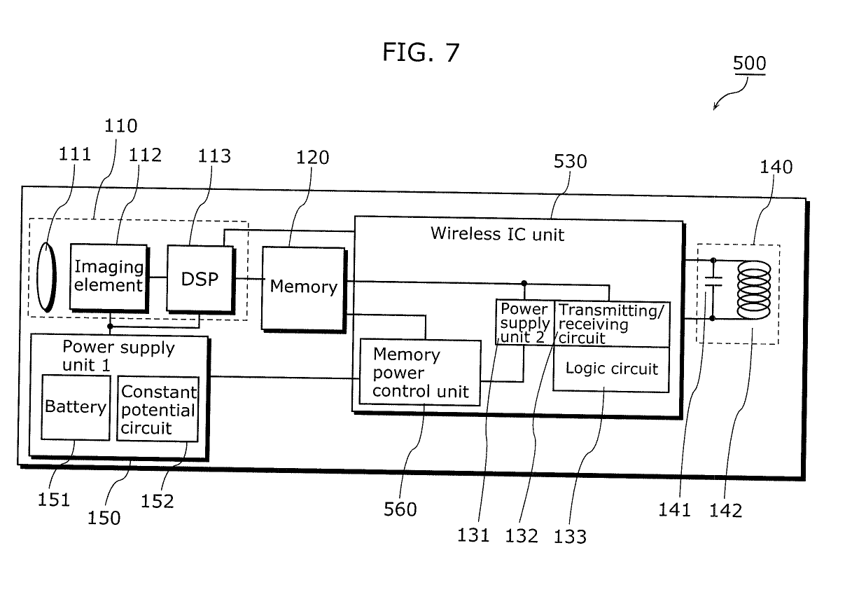

FIG. 7 is a block diagram illustrating a configuration of a camera module 500 according to Embodiment 4 in the present invention. FIG. 7 illustrates an example of a configuration different from those of Embodiments 1 and 3.

Embodiment 4 differs from Embodiment 1 in that the memory 120 and the memory power control unit 160 are different constituent elements in Embodiment 1, whereas a wireless IC unit 530 includes a memory power control unit 560 in Embodiment 4.

Since the operating sequences of the camera module 500 and the transmitting/receiving device 200 are the same as the imaging sequences of Embodiment 1 or Embodiment 2, the description will be omitted.

With the configuration of the camera module 500 in Embodiment 4, the number of components to be mounted on the camera module 500 can be reduced. Thus, the camera module can be further downsized.

### Embodiment 5

The following describes Embodiment 5. The description of the same configuration and operations as those of Embodiments 1 to 4 will be omitted.

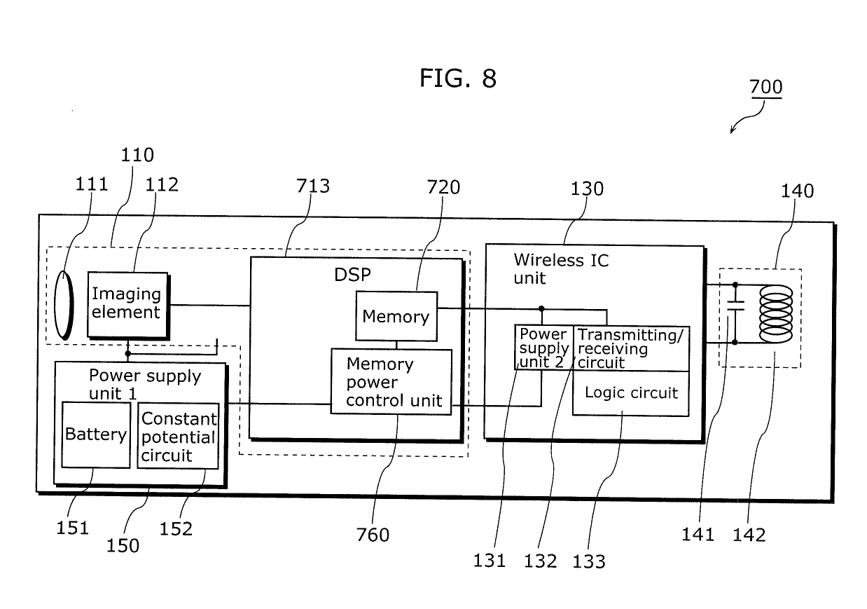

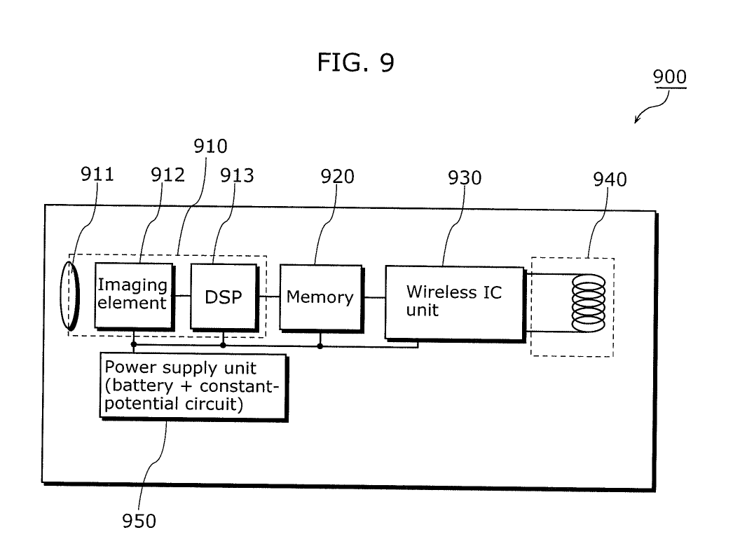

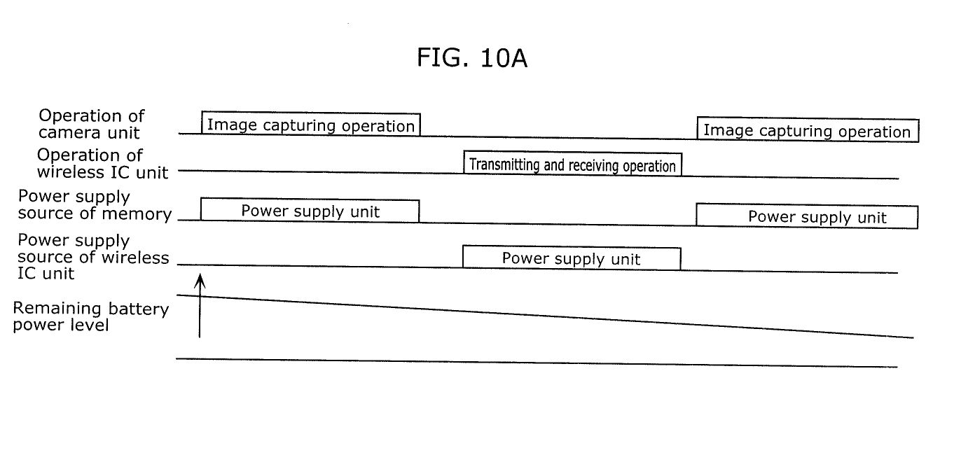

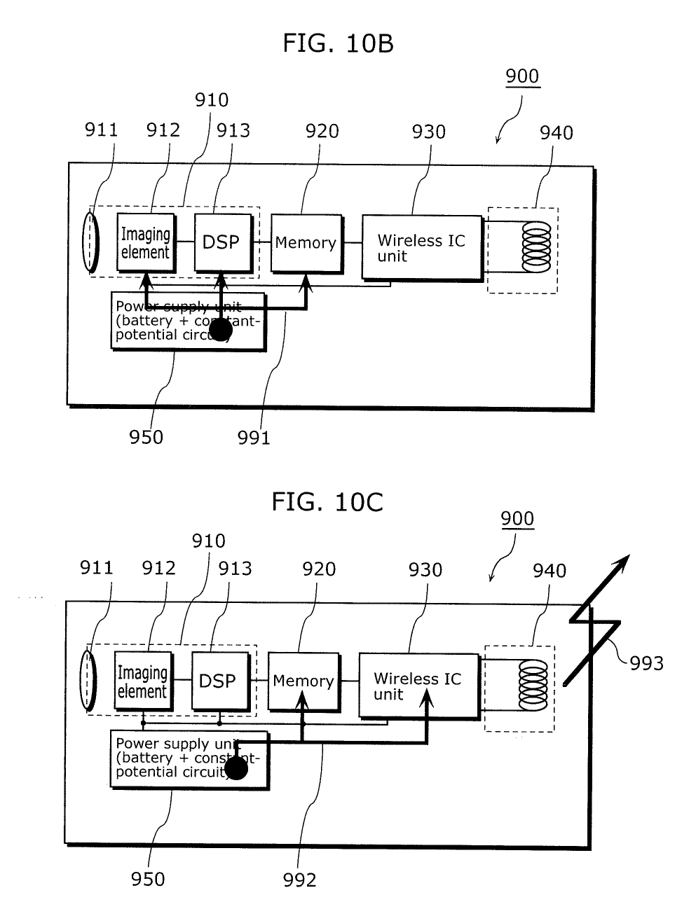

FIG. 8 is a block diagram illustrating a configuration of a camera module 700 according to Embodiment 5 in the present invention. FIG. 8 illustrates an example of the configuration different from those of Embodiments 1 and 4.

Embodiment 5 differs from Embodiment 1 in that the DSP 113, the memory 120, and the memory power control unit 160 are different constituent elements in Embodiment 1, whereas a DSP 713 includes a memory power control unit 760 and a memory 720 in Embodiment 5.

Since the operating sequences of the camera module 700 and the transmitting/receiving device 200 are the same as those of Embodiment 1 or Embodiment 2, the description will be omitted.

With the configuration of the camera module 700 in Embodiment 5, the number of components to be mounted on the camera module 700 can be reduced. Thus, the camera module can be further downsized.

As described above, the camera module includes a wireless device, and supplies the memory that stores image data captured by a camera, with power not only from the wireless device but also through induced electromotive force from electromagnetic waves externally received by the wireless device.

Thus, the power consumed by the battery 151 of the power supply unit 150 is smaller in amount even with frequent wireless transmission, and the operating time of the camera equipment is not shortened (the number of captured images does not decrease). Thus, there is no need to upsize the battery 151 to increase the operating time. Thereby, the camera module 100 allowing for its downsizing and reduction in the power consumption can be implemented.

For example, although the camera unit 110 includes the imaging element 112 and the DSP 113 in Embodiment 1, the imaging element 112 and the DSP 113 may be integrated into an LSI.

Furthermore, the DSP 113 included in the camera unit 110 in Embodiment 1 may compress the image data in a compression method, such as JPEG.

Although the camera module according to the present invention is described based on Embodiments, the present invention is not limited to such Embodiments. Without departing from the scope of the present invention, the present invention includes an embodiment with some modifications on Embodiments that are conceived by a person skilled in the art, and another embodiment obtained through combinations of the constituent elements of different Embodiments in the present invention.

### INDUSTRIAL APPLICABILITY

The present invention is applicable to a camera module, and in particular to a camera module to be used in the field of monitoring cameras and cameras for medical use.

1. A camera module that transmits and receives data to and from an other apparatus via wireless communication, said camera module comprising:
a camera unit configured to capture images of objects and provide information of the captured images as image data;
a memory in which the image data is stored;
an antenna unit used for transmission and reception via wireless communication;
a wireless communication unit configured to transmit the image data via wireless communication;
an electromagnetic-wave power supply unit configured to receive electromagnetic waves used for wireless communication via said antenna unit and to generate power by electromagnetic induction through the received electromagnetic waves or by a radiated electromagnetic field;
a power supply unit configured to supply the power at least to said camera unit; and
a memory power control unit configured to select one of said electromagnetic-wave power supply unit and said power supply unit as a power source of said memory according to a state of said camera module.

2. The camera module according to claim 1,
wherein said wireless communication unit is further configured to receive, via wireless communication, control information for controlling said camera unit, and
said camera unit is configured to capture the images according to the control information.

3. The camera module according to claim 2,
wherein said memory power control unit is configured to select said electromagnetic-wave power supply unit while said wireless communication unit is transmitting the image data or receiving the control information.

4. The camera module according to claim 1,
wherein said memory power control unit is configured to select said power supply unit when an amount of the power generated by said electromagnetic-wave power supply unit is equal to or smaller than a predetermined threshold.

5. The camera module according to claim 1,
wherein said memory is a nonvolatile memory, and
said memory power control unit is further configured to stop the power supply to said memory, while said camera unit and said wireless communication unit are not operating.

6. The camera module according to claim 2,
wherein said wireless communication unit is configured to store the received control information in said memory,
said camera unit is configured to capture the images according to the control information stored in said memory, and
the control information includes at least one of an image-capturing start signal, an exposure time, a gain at the time of capturing the images, and image-capturing intervals.

7. The camera module according to claim 1,
wherein said wireless communication unit is configured not to transmit the image data stored in said memory while said camera unit is capturing the images.

8. The camera module according to claim 1,
wherein new image data is not stored in said memory while said wireless communication unit is transmitting the image data or receiving the control information.

9. The camera module according to claim 1,
wherein said camera unit includes:
an imaging element that captures the images of the objects; and
a signal processing unit configured to perform signal processing on the information of the images captured by said imaging element, and provide the processed information as the image data, and
said signal processing unit is further configured to control said camera unit, said memory, and said wireless communication unit.

10. The camera module according to claim 1,
wherein said wireless communication unit, said electromagnetic-wave power supply unit, and at least one of said memory and said memory power control unit are included in an integrated circuit.

11. The camera module according to claim 8,
wherein said signal processing unit, and at least one of said memory and said memory power control unit are included in an integrated circuit.

12. An integrated circuit included in a camera module that transmits and receives data to and from an other apparatus via wireless communication and includes a camera unit that captures images of objects and provides information of the captured images as image data, said integrated circuit comprising:
a memory in which the image data is stored;
an antenna unit used for transmission and reception via wireless communication;
a wireless communication unit configured to transmit the image data via wireless communication;
an electromagnetic-wave power supply unit configured to receive electromagnetic waves used for wireless communication via said antenna unit and to generate power by electromagnetic induction through the received electromagnetic waves or by a radiated electromagnetic field;
a power supply unit configured to supply the power at least to said camera unit; and
a memory power control unit configured to select one of said electromagnetic-wave power supply unit and said power supply unit as a power source of said memory according to a state of said camera module.
